(19) United States
(12) Patent Application Publication
(10) Pub. No.: US 2025/0319836 A1
(43) Pub. Date: Oct. 16, 2025

(54) METHOD FOR TRIGGERING PROTECTIVE MEANS, AND CHILD RESTRAINT DEVICE COMPRISING PROTECTIVE MEANS

(71) Applicant: CYBEX GmbH, Bayreuth (DE)

(72) Inventors: Thomas MÜLLER, Bayreuth (DE); Christoph THURN, Bayreuth (DE); Jiri SPOUR, Zlatniky-Hodkovice (CZ)

(21) Appl. No.: 18/705,085

(22) PCT Filed: Oct. 21, 2022
(86) PCT No.: PCT/EP2022/079411

§ 371 Date: Jun. 18, 2025

(30) Foreign Application Priority Data
Oct. 26, 2021 (DE) 10 2021 127 797.3

(51) Int. Cl. B60R 21/0132; B60N 2/26; B60R 21/00; B60R 21/01; B60R 21/231; B60R 21/235; B60R 21/239; B60R 21/264; B60R 22/10; G01P 15/18

(52) U.S. Cl. CPC B60R 21/01332; B60N 2/273; B60R 21/231; B60R 21/235; B60R 21/239; B60R 21/264; B60R 22/105; G01P 15/18; B60N 2210/00; B60R 2021/006; B60R 2021/01034; B60R 2021/01272

(57) ABSTRACT

The invention relates to a method for triggering protective means, in particular an airbag and/or a belt tensioner, in a child restraint device, in particular according to one of claims 18 to 20, comprising the steps of: a) determining at least one measurement direction and/or a measurement direction corridor; b) receiving acceleration sensor signals from at least two acceleration sensors (74x, 74y, 74z), which are preferably orientated differently; c) calculating at least one first acceleration value (aX) along the measurement direction and/or within the measurement direction corridor; d) determining a triggering signal based at least on the at least one first acceleration value (aX); e) triggering at least one protective means based on the triggering signal.

The invention relates to a child restraint device, in particular a child seat and/or impact shield, for mounting in a vehicle seat, comprising at least one (active) protective means as well as a method for triggering protective means.

DE 4 418 028 A1 describes a child seat with an impact shield, which in turn comprises an airbag. The airbag is arranged in an upper section of the impact shield in order to protect the head of the child sitting in the child seat (in the event of an impact).

DE 20 2017 105 118 U1 also discloses a child seat with an impact shield. According to this state of the art, an airbag can be arranged at various positions, for example in an upper section or in a lower section of the impact shield or in the centre of the impact shield in order to spread an upper and a lower section of the impact shield apart from each other. Furthermore, DE 20 2017 105 118 U1 describes a child seat with protective means in the form of a belt system that can be closed upon exceeding an acceleration value.

DE 10 2017 126 235 A1 describes a child seat with an impact shield that has an airbag, which is arranged either in a lower section or a rear section (facing the child sitting in the child seat).

DE 19 722 095 C1 describes a child seat with a support bracket in which an airbag is arranged. When triggered, a gas bag of the airbag unfolds, which should take place in as controlled a manner as possible.

DE 4 418 028 B4 shows various ways of positioning an airbag on a child seat. A gas generator is arranged directly next to the gas bag in each case.

U.S. Pat. No. 5,375,908 A shows a child seat with an airbag, whereby a gas generator is arranged in the seat section of the child seat.

DE 19 534 126 C1 describes a gas cartridge integrated into a seat part of a child seat, which feeds an airbag via a pressurised line.

EP 1 452 386 B1 describes an airbag in a chest pad, which is arranged in a hollow housing.

U.S. 6,736,455 B1 describes an airbag that is arranged under a cushion-like section in its initial state.

A child seat with active protective means (e.g. airbag) is known from EP 2911910 B1, whereby the airbag is only triggered if both a use of the child seat as well as an accident situation are detected, whereby the accident situation is detected by means of detection means which have both mechanical and electronic means.

A child seat with active protective means (e.g. airbag) is known from EP 2911910 B1, wherein the airbag is only triggered if the acceleration of the child seat exceeds a first threshold value in a first time interval and a second threshold value in a second time interval, wherein the second time interval is contained in the first and the second threshold value is greater than the first threshold value.

In EP 3406481 B1 a child seat is described comprising a seat and a seat base and having active protective means (e.g. airbag), wherein the airbag cannot be triggered while a tilt of the seat is adjusted with respect to the seat base.

So far, the various solutions with active protective means (especially airbag solutions) for child seats have not been able to take hold on the market. This is possibly due to requirements that are sometimes difficult to bring in line, such as:
Safe and reliable use of the protective means (in particular, avoidance or at least reduction of any risks that may only result from the airbag);
acceptable additional effort for the user;
ease of use.

Trigger control in particular poses a problem, as standard child seats are not connected to the vehicle's electrical system. This means that the child seat requires its own reliable power supply and its control system often cannot access the vehicle's numerous available sensor information.

It is therefore object of the invention to provide a child restraint device with protective means as well as a method for triggering corresponding protective means, which overcomes the problems of the prior art. In particular, the device and the method should be safe and easy to operate as well as lead to a reliable triggering.

This object is solved in particular by the features of claim 1.

In particular, the object is solved by a method for triggering protective means in a child restraint device in a vehicle, wherein the method comprises:
a) Determining at least one measuring direction and/or a measuring direction corridor;
b) receiving acceleration sensor signals from at least two acceleration sensors, which are preferably orientated differently;
c) calculating at least one first acceleration value along the measurement direction and/or within the measurement direction corridor;
d) determining a triggering signal based on at least the at least one first acceleration value;
e) triggering the active protective means based on the triggering signal.

Thus, one aspect of the invention is based on using and evaluating several acceleration sensors, wherein for certain aspects preferably acceleration components are taken into account which act in a certain direction, namely the measurement direction, and/or lie within a certain measurement direction corridor. The measurement direction corridor can, for example, be a volume body such as a cone, which is rotationally symmetrical around the measurement direction, or, for example, an angular range around the measurement direction. The measurement direction corridor can also be specified by a plane or a vector.

The determination of a triggering signal based at least on the at least one first acceleration value can comprise a direct and an indirect determination of the triggering signal. For example, the acceleration value can be used to detect the presence of a precondition for giving the triggering signal. The immediate criterion for giving the triggering signal can possibly be determined based on other signals or values, for example using the acceleration sensor signals. In one embodiment, an alarm mode is adopted based on the at least one first acceleration value.

The acceleration sensors are preferably differently orientated acceleration sensors. Such acceleration sensors are often combined in a unit, for example an acceleration sensor unit. In one embodiment, an acceleration sensor unit is used that measures acceleration values on at least two axes, preferably on three axes. Preferably, the axes used can be perpendicular to each other.

The calculating of the at least one acceleration value that occurs along a measurement direction and/or within a measurement direction corridor has the advantage that an acceleration pattern characteristic of an accident that occurs in certain directions can be evaluated. This means that false triggering can be avoided, that, for example, occur due to careless handling of the child restraint device. This includes blows when installing the child restraint device and/or adjusting the alignment of the child restraint device within the vehicle. The child or baby itself can also trigger acceleration forces on or at the child restraint device, which could well be able to cause a false triggering. By taking into account certain acceleration values, which preferably occur along certain directions, an unwanted triggering can be prevented. Furthermore, the evaluation of calculated acceleration values that occur along (different) predefined axes can be used to implement an accident-specific triggering behaviour. For example, different gas bags and/or gas bag sections, or the same gas bags and/or gas bag sections in a different sequence, can be filled in a frontal accident than in a side crash. As already explained, the occurrence of a certain acceleration value does not have to lead directly to the triggering of the respective protective means, but can be a precondition for a specific triggering.

In one embodiment, a plurality number of acceleration values, in particular of first acceleration values, are determined over time. The determined or calculated first acceleration values can be taken into account when triggering the active protective means. In one embodiment, an evaluation of these acceleration values is done over time in such a way that they are compared with characteristic value courses over time, so that triggering only takes place if there is at least substantially a match. According to the invention, however, various other evaluations can also be carried out over time. For example, threshold value comparisons can be carried out at specific points in time.

In one embodiment, an alarm mode is adopted when at least one alarm criterion is fulfilled. An alarm criterion can be, for example, if one of the acceleration values, in particular of the calculated acceleration values, for example the first calculated acceleration value, is above a threshold value (at least once). The threshold value can preferably be above more than 0.5 g (g=normal acceleration due to gravity=9.81 m/s²) and/or at less than 5 g. The threshold value is particularly preferably in a range between 1.5 g and 2.5 g. These threshold values result in the alarm mode being only activated at higher acceleration values in predefined directions. At the same time, the threshold value is not set so high that potential triggering situations are “overlooked” or recognised too late.

One advantage of the invention is that at least the alarm criteria, which are based on acceleration values, can be determined using simple force sensors. Force sensors are very energy-saving in use, so that small energy stores are sufficient to implement the described methods in a device.

Further, preferably additional, alarm criteria can also be defined. For example, it may be that a measured temperature lies within a predetermined interval, preferably in the interval from −30° C. to 100° C., e.g. −20° C. to 40° C. In one embodiment, the temperature is measured on the active protective means (e.g. on the airbag) themselves and/or on the control unit.

The alarm mode can be regarded as a preliminary stage to a triggering. In alarm mode, for example, it is possible to check at very short intervals, e.g. at least every 2 milliseconds (ms), preferably at least every millisecond, whether the active protective means should be triggered (in particular whether the airbag should be triggered). A possible check interval can be in the range of 0.2 ms to 0.8 ms.

In other words, at least one triggering criterion can be checked repeatedly in alarm mode. This may, for example, be the monitoring of at least one acceleration values determined on the basis of at least one of the acceleration sensor signals and/or a value calculated on the basis of this first acceleration value. In one embodiment, a differential speed calculated on the basis of at least one acceleration value is monitored or the exceeding of a threshold value by the calculated differential speed is used as a triggering criterion.

In one embodiment, the differential speed is calculated using several acceleration values. For example, for each acceleration sensor signal received one acceleration value (e.g. for different sensor axes) can be determined.

According to the invention, the same force sensors can be used as acceleration sensors to determine at least one trigger criterion and at least one alarm criterion. The hardware requirements for implementing the method are therefore low. The fewer sensors required, the lower the power consumption.

According to the invention, it is envisaged to calculate several differential speeds for at least one acceleration value and to compare these with different threshold values. For example, threshold values that vary over time can be used. In one embodiment, a differential speed is calculated several times starting from a state at the time at which a transition to alarm mode last took place.

In one embodiment, the acceleration values (of one axis or several axes) are integrated over time or added up in another suitable manner in order to determine a differential speed (compared to the speed at the time of the transition to the alarm state) starting from said point in time. Any acceleration values can be taken into account for this purpose.

In one embodiment, triggering is linked to at least two triggering criteria:
a) the differential speed exceeds a threshold value that is, possibly individually, assigned to the point in time;
b) the acceleration values used to determine the differential speed lie (predominantly) within a target corridor with regard to their direction of action.

The target corridor can be specified by a vector. Preferably, the target corridor is specified by a vector and an angle. The target corridor can be the measurement direction corridor already described. The target corridor can be a one-dimensional vector, a two-dimensional surface or a three-dimensional body. In this respect, the term target corridor includes the term target direction. Preferably, this is a cone.

Determining the effective direction can involve adding up and possibly normalising acceleration vectors that have been determined or measured since the (last) transition to the trigger mode. This can ensure that the differential speed ultimately leading to triggering is based on accelerations/acceleration vectors that lie (predominantly, e.g. more than 50%) within the target corridor.

In one embodiment, a triggering criterion can be fulfilled if the calculated differential speed still has a sufficiently high value even after a predefined dead time. This dead time can, for example, be selected in an interval between 1 and 50 ms, preferably between 2 and 10 ms. After exceeding this dead time, the differential speed can be compared with threshold values which, in one embodiment, decrease (continuously) in a time interval following the dead time, so that triggering is relatively likely if a correspondingly high differential speed is present during this period. After this time interval, in at least one embodiment, the threshold values increase again in a subsequent time interval. Preferably, there is a maximum time that ensures that the alarm mode is exited again provided that no triggering criterion was fulfilled in the previous time period.

The alarm mode can be terminated if one or more cancellation criteria are met. The cancellation criteria can include:
i) a timeout, in particular exceeding a maximum time interval since the (last) transition to alarm mode; and/or
ii) exceeding a maximum number of calculation steps, in particular of calculation step c); and/or
iii) falling below a threshold value by an acceleration value, in particular by the first acceleration value; and/or
iv) falling below a threshold value by a differential speed calculated on the basis of an/the acceleration value(s).

The triggering of the active protective means can also be linked to several triggering criteria. These can be selected from the following in addition to at least one of those already mentioned:
A measured temperature is within a specified interval, preferably in the interval from −30° C. to 100° C., e.g. −20° C. to 40° C. In one embodiment, the temperature is measured on the active protective means (e.g. on the airbag) themselves and/or on the control unit.
A further, in particular secondary, acceleration sensor unit has determined or calculated an acceleration value that exceeds a threshold value in at least one measurement since the start of the alarm mode. For example, this may be the threshold value of 2.5 g. In one embodiment, this can be an acceleration value that is greater than 2 g.

The secondary acceleration sensor unit has calculated and/or measured an acceleration value that exceeds a predefined threshold value on average (using a suitable average value) since the start of the alarm mode. This threshold value can be at 2 g or at 1.5 g.

In one embodiment, the method comprises at least one calibration step. Preferably, the method can implement a calibration state, i.e. a mode in which a calibration is performed over a certain period of time. In said calibration mode or in the calibration step, a reference plane is determined using a gravitational vector, in particular of a gravitational force g. This reference plane can be used to determine the measurement direction or the measurement direction corridor. The gravitational vector can be determined using the acceleration sensor signals.

In one embodiment, the reference plane may be a vehicle plane, preferably comprising a direction of travel vector, wherein the vehicle plane is determined using a restraint device reference data, for example s a restraint device tilt angle.

The transition to calibration mode can be made from a lock mode. After the calibration mode, it is possible to transition to a standby mode. In one embodiment, the calibration mode is also the standby mode or a possible embodiment thereof. It may be envisaged a switch from calibration mode or standby mode back to lock mode is envisaged if predetermined conditions are not (or no longer) met, for example immediately or if this is the case for a predetermined time (e.g. two minutes).

In calibration mode, a calibration loop can be run through (several times). For that, in a first step, the acceleration can be detected by the acceleration sensor unit. By detecting the orientation in relation to the acceleration due to gravity, the orientation of the seat or the seat coordinate system or the coordinate system of the acceleration sensor unit can be determined in a second step. Then, in a third step, the acceleration in the direction of measurement (for example, in the direction of travel of the vehicle and/or in the direction of the horizontal component of the direction of travel) can be determined.

Here, “in the direction of the horizontal component of the direction of travel” means in particular that the direction is orientated horizontally (i.e. perpendicular to the acceleration due to gravity) and has no lateral component in relation to the direction of travel. Finally, it may be envisaged to repeat the aforementioned steps at the predetermined frequency until a cancellation event occurs.

Specifically, the calibration loop can therefore comprise the following steps, whereby in this embodiment it is assumed that an x-axis of the acceleration sensor unit has no lateral component, the coordinate system of the vehicle seat is congruent with the coordinate system of the vehicle and the x-axis of the acceleration sensor unit or the corresponding coordinate system rises by an angle alpha. In other words, the x-axis of the acceleration sensor unit intersects the vehicle plane at an acute angle alpha. Furthermore, it is assumed for this embodiment that a z-axis of the acceleration sensor unit also has no lateral component and is perpendicular to the x-axis):
1. Measurement of the accelerations a1 and a3 in the direction of the respective axes.
2. Determination of an angle beta, which relates the vehicle plane to the horizontal plane. It may be intended only to consider only realistic angles for beta, e.g. in such a way that the amount of beta in degrees can be a maximum of 25.
3. Determination of the acceleration a_{dr} in the direction of travel (in the vehicle plane) and/or a_{drh} in the direction of the horizontal component of the direction of travel by adding the corresponding components of a1 and a3.

In addition to the inclination of the vehicle plane relative to the horizontal plane, further offset angles according to the invention can be taken into account:
Offset angle gamma: Inclination of the child seat coordinate system relative to the vehicle plane;
Offset angle alpha: Inclination of the coordinate system of the acceleration sensor unit relative to the child seat coordinate system.

Gamma can be estimated and/or determined by a separate measurement (e.g. if it is known that the vehicle is currently on a horizontal plane) and/or specified by input from a user. In one embodiment, gamma is estimated, preferably using a value from 0 to 30°, more preferably a value from 10° to 20°.

The method can comprise storing and/or reading out of stored values. A preset value for beta can be used at the start of the calibration loop if no measurements are available or the number of measurements is too low. Alternatively, a value of beta determined during a previous use of the child seat (in particular the last value determined, which may have been stored for this purpose) can be used.

In one embodiment, it may be envisaged that the transfer from the calibration mode to an alarm mode is not permitted until a predetermined number of measurements have been taken.

In one embodiment, it may be envisaged that the calibration is stopped when the alarm mode is entered.

In another embodiment, it may be envisaged that the calibration continues to run in the background. In this case, the calculations can (preferably) still be based on the measurement direction (or the corresponding measurement direction corridor) of the calibration determined when entering the alarm mode, or the calculations can be based on a continuously updated measurement direction (or the corresponding measurement direction corridor).

### First Variant: Averaging

In one embodiment, it may be provided to form an ensemble of measurements (in the calibration mode) such that an ensemble contains a plurality of results of measurements. Preferably, the plurality of measurements of an ensemble can consist (exclusively or partially) of directly consecutive measurements. The plurality and/or a number of directly consecutive measurements may be a number of more than 100 or more than 1000 or more than 10000. A plurality and/or the number of directly consecutive measurements may comprise measurements from a time interval of more than one second or more than five seconds or more than 20 seconds, and/or measurements from a time interval of at most 10 minutes or at most 90 seconds.

Furthermore, it may be envisaged to form successive ensembles that directly follow one another or that overlap (in each case with respect to the measured values associated with the ensembles). In particular, it may also be envisaged to form only a single ensemble and to update it continuously by adding a new (preferably the current) measured value to the ensemble and for it removing another (preferably the oldest) measured value from the ensemble.

When an ensemble is formed, it may be envisaged, in relation to the second step, to first calculate each of a1 and a3 from the individual measured values using a suitable mean value (e.g. the arithmetic mean, the geometric mean, the harmonic mean or the median) and then to infer the angle beta or the angle sum alpha+beta from this mean value. It may also be envisaged to calculate an angle or an angle sum for each individual measurement and to determine beta or alpha+beta from the thus obtained results by forming a suitable mean value.

### Second Variant: Iterative Adjustment

Alternatively to averaging (first variant), it may be envisaged to update the angle beta iteratively in the calibration mode. To do this, either beta itself can be updated iteratively, or each of a1 and a3 are updated iteratively and used to calculate beta.

If beta itself is to be updated iteratively, it may be envisaged to necessary to offset a known value of beta (in particular a value of beta determined by measurement, preferably the most recent value of beta determined by measurement) against a value determined from a new measurement. If the known value is labelled betaₐₗₜ and the value determined from the new measurement is labelled betaₙₑᵤ, the following can apply, for example: beta=a*betaₐₗₜ+b*betaₙₑᵤ, where a and b are factors. Preferably, a and b are each constant, and preferably a+b=1. a is preferably greater than b, in particular at least twice as great. As soon as a new measurement result is available, betaₐₗₜ can be set to the value of beta and a new offsetting can be carried out. In this way, a current value for beta that is robust against outliers can always be provided with very little memory and low energy consumption.

In one embodiment, the at least one calculated acceleration value can also be determined or updated iteratively. This can be done in the manner already described for beta, i.e. by offsetting each time a known value with a value determined from a new measurement. Preferably, the calculation is also carried out using (possibly constant) factors as already described for beta.

In one embodiment, at least one sleep mode criterion is determined, in particular using the acceleration values and/or the sensor signals, whereby a sleep mode is adopted if the at least one sleep mode criterion is present. This sleep mode or the sleep mode criterion can be used to reduce the energy consumption of the device implementing the method. For example, in sleep mode, a determination of acceleration values, in particular of the first acceleration value, can be determined with a first frequency that is (significantly) smaller than a second frequency associated with a non-sleep mode.

The sleep mode criterion can be a comparison of the sensor signals or the acceleration values with expected acceleration values that occur when only the acceleration due to gravity occurs. A certain tolerance can also be provided in this respect, so that for a predetermined time interval some or all of the measured values of the acceleration sensors must lie around the value of the acceleration due to gravity in order to fulfil the sleep mode criterion.

The sleep mode can be exited if at least one of the determined acceleration values or the measured acceleration sensor signals is no longer within the specified interval. For example, the previously described calibration mode or a calibration step can be run through after exiting sleep mode.

If the state of the harness is not already a criterion for exiting lock mode, the state of the harness can alternatively or additionally—preferably independently of the aforementioned criterion—be taken into account as a criterion for entering sleep mode. It may be envisaged that sleep mode is entered when the harness is open (immediately or after a predetermined time). When the harness is closed, sleep mode can be exited again.

The object mentioned at the beginning is also solved by the following methods. Similar or analogous advantages to those described result.

Method for triggering (active) protective means, comprising the steps of:
a) Receiving acceleration sensor signals from at least one acceleration sensor;
b) calculating at least a first acceleration value;
c) calculating a differential speed;
d) determining a triggering signal based on at least the differential speed;
e) triggering the airbag based on the triggering signal.

The differential speed can be based on the first acceleration value or directly based on the acceleration sensor signals. In the latter embodiment, the calculation of the at least one first acceleration value may be omitted, if necessary.

Method for triggering (active) protective means, comprising the steps of:
a) Receiving first acceleration sensor signals from at least one acceleration sensor;
b) determining, preferably iteratively determining, at least one measurement direction and/or a measurement direction corridor based on the first acceleration sensor signals;
c) receiving second acceleration sensor signals from (the) at least one acceleration sensor;
d) determining a triggering signal based on at least the second acceleration sensor signals;
e) triggering the airbag based on the triggering signal.

The first and second acceleration sensor signals may be signals that originate from different acceleration sensors. Alternatively or additionally, they may be signals that are received at different times, wherein at least one second acceleration sensor signal is received after a first acceleration sensor signal in each case. In one embodiment, the second acceleration sensor signal originates from the same acceleration sensor as the first.

A method for triggering (active) protective means, comprising the steps of:
a) Determining at least one measurement direction and/or a measurement direction corridor;
b) receiving acceleration sensor signals from at least one acceleration sensor;
c) calculating at least one first acceleration value;
d) comparing the at least one first acceleration value with the measurement direction and/or the measurement direction corridor;
e) determining a triggering signal based at least on the result of the comparison;
f) triggering the airbag based on the triggering signal.

A method of triggering (active) protective means comprising the steps of:
a) Checking conditions for entering a standby mode, wherein the conditions include at least one condition of:
   correct coupling of the child restraint device to a vehicle seat,
   detection of a child in the child seat,
   correct securing of a child in the restraint device,
   correct installation of a support foot of the restraint device;
b) receiving acceleration sensor signals from at least one acceleration sensor;
c) determining a triggering signal based on at least one acceleration value and/or on the acceleration sensor signals;
d) triggering the airbag based on the triggering signal.

The protective means of the preceding methods may be airbags. The methods may be used in conjunction with child restraint devices, in particular as described below. The methods can be combined in each case with the embodiments described above, in particular the embodiments of claims 1 to 11, and/or partial aspects thereof. The methods are suitable for triggering protective means in vehicles.

The object mentioned at the beginning is also solved by a computer-readable storage medium or by a computer-readable memory with instructions for implementing one of the methods already described.

Furthermore, the object can be solved by a control and regulation unit which is designed to implement the said methods during operation.

Similar or analogous advantages to those already described in connection with the method result.

The object mentioned at the beginning is also solved by a child restraint device with a longitudinal axis, a transverse axis and a vertical axis, in particular a child seat and/or impact shield, for installation in a vehicle or by a component of such a vehicle. The child restraint device can then comprise the following:
at least one (active) protective means, in particular an airbag with at least one inflatable gas bag,
at least one drive unit, in particular a gas generator, for activating the at least one protective means,
at least one control unit for activating the drive unit by means of a triggering signal,
at least one sensor unit with a first acceleration sensor and with a third acceleration sensor for outputting first acceleration sensor signals and third acceleration sensor signals respectively,
   wherein the control unit preferably receives the acceleration sensor signals and decides on the basis of the first and third acceleration sensor signals whether the drive unit is activated.

Here too, similar advantages to those already described in connection with the method result. As explained, the child restraint device can comprise a sensor unit with at least two acceleration sensors. Preferably, these several acceleration sensors are used in such a way that only accelerations occurring in a specific direction are utilised. Alternatively, several acceleration values acting in different directions can also be taken into account, although a separate evaluation shall be carried out in accordance with the invention.

The child restraint device or said component may comprise a primary and a secondary sensor unit, each with at least two acceleration sensors. In one embodiment, three acceleration sensors are provided, which preferably supply acceleration sensor signals orthogonally to one another. In one embodiment, the acceleration sensors of the primary sensor unit are sampled more frequently than those of the secondary sensor unit. The primary sensor acceleration unit can be sampled at a first predetermined frequency which is, for example, higher than 10 Hz, preferably higher than 100 Hz or even higher than 1 kHz. In one embodiment, the acceleration sensors of the primary sensor unit are sampled at a sampling rate that is lower than 10 KHz.

In one embodiment, the first acceleration sensor (x-axis) and the third acceleration sensor (z-axis) for detecting a first acceleration value (x-axis) and a third acceleration value (z-axis), respectively, are arranged in a detection direction, wherein the detection direction extends in or parallel to a plane spanned by the vertical axis and the longitudinal axis of the child restraint device.

In one embodiment, the first acceleration sensor and the third acceleration sensor are arranged (at least substantially) orthogonally to each other. The use of the term “substantially” in connection with directional information can mean (here, in the foregoing and/or in the following) that the directional information deviate by a maximum of 20° or by a maximum of 15° from the specified direction. The sign of the deviation is irrelevant here, so that an interval of +20° to −20° or +15° to −15° is spanned.

The second acceleration sensor (y-axis) can be aligned (at least substantially) parallel or coaxial to the transverse axis of the child restraint device.

To detect the first acceleration value, the acceleration sensor can be arranged in a/the detection direction that has an angle of more than 5° and/or less than 30° relative to a longitudinal axis of the vehicle.

The possibilities discussed so far for aligning the acceleration sensors are advantageous, in particular with regard to any calculations and decisions (e.g. by the control unit) made on the basis of the measured accelerations. However, other configurations are also possible. In principle, an alignment of different acceleration sensors orthogonal to each other is not compulsory. By aligning them at a different angle to each other, the accuracy of the measurement in one direction can be improved at the expense of the measurement accuracy in another direction.

Possible is also an alignment of, for example, two or three acceleration sensors (preferably symmetrically to a longitudinal axis of the child seat or to a longitudinal axis of the vehicle) in such a way that each of these acceleration sensors has a component (preferably of the same size) in the direction of the longitudinal axis of the child seat or to the longitudinal axis of the vehicle. This has the advantage that detection of the expectedly greatest acceleration (namely in the direction of travel of the vehicle when travelling straight ahead or in the direction of the longitudinal axis of the vehicle) can be distributed across all three acceleration sensors and thus be particularly efficient-higher accelerations can therefore be detected with the same measuring range of the individual acceleration sensors. In one embodiment, for example, two or three acceleration sensors can be arranged at 45° to the longitudinal axis of the vehicle or to the longitudinal axis of the child seat and at the same time be orthogonal to each other.

In principle, most aspects of the present invention can also be realised with a single sensor. This one sensor can preferably lie in the plane spanned by the x-axis and z-axis and be inclined upwards at an angle of 20° to 40° to the x-axis.

The child restraint device according to the invention can have at least one acceleration sensor unit which has acceleration sensors for more than one direction (e.g. a triaxial sensor). The acceleration sensor unit can be provided near a rear side of the child seat (i.e. on a side of the child seat facing the backrest of the vehicle seat). Additionally or alternatively, the acceleration sensor unit can be provided close to an underside of the child seat (i.e. on a side of the child restraint device facing the seat surface of the vehicle seat). Preferably, the acceleration sensor unit is arranged in the centre (in relation to a lateral direction of the child restraint device) and/or close to an (imaginary) connecting line between rear fastening means of the child restraint device. Here, close can mean that a distance is a maximum of 10 cm.

A first acceleration sensor (x-axis) can be aligned so that its lateral component is zero. In particular, the first acceleration sensor can at least substantially (in relation to the direction of travel when travelling straight ahead) be aligned so that it rises slightly from the rear to the front (cf. offset angle gamma).

Preferably, gamma is an acute angle, more preferably an angle of more than 5° and/or less than 30°. Particularly preferable it is an angle of 7°-18°.

A second acceleration sensor (y-axis) of the acceleration sensor unit can be laterally aligned perpendicular to the first acceleration sensor.

A third acceleration sensor (z-axis) can be aligned perpendicular to the first and second acceleration sensors, respectively.

Several acceleration sensor units can be installed in the child restraint device. At least one of the acceleration sensor units can be operated as a primary unit.

The (primary) acceleration sensor unit can detect the acceleration or measure acceleration values at a first predetermined frequency. The predetermined frequency can, for example, be more than 10 Hz, preferably more than 100 Hz, particularly preferably more than 1 kHz. In addition, the predetermined frequency may possibly be at most 10 KHz.

The secondary acceleration sensor unit can detect the acceleration or measure acceleration values at a second predetermined frequency, wherein the second predetermined frequency should preferably be lower than the first predetermined frequency (e.g. 30%-70% of the first predetermined frequency).

The child restraint device can have at least one energy storage device, in particular a battery (e.g. a lithium-ion accumulator), for supplying the control unit and/or the gas generator. In one embodiment, the gas generator works with a fluid reservoir and/or with pyrotechnics. However, it is also possible to operate the gas generator electrically. Preferably, the control unit in the child restraint device is powered by its own energy storage unit, so that it is not necessary to connect the child restraint device to the vehicle's electrical system.

Further advantageous embodiments are shown in the dependent claims.

The invention is explained below with reference to a some figures. These show:

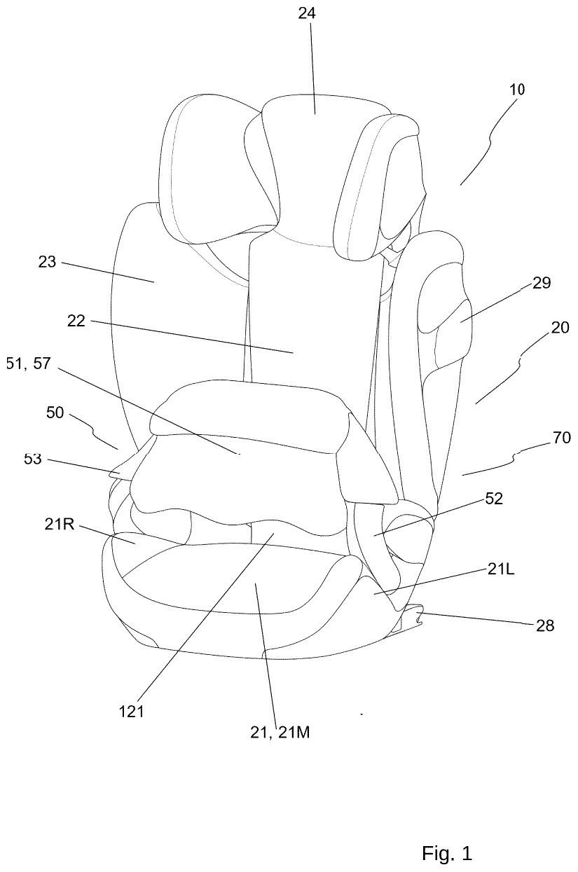

FIG. 1 a perspective view of a first child seat with airbag (no base);

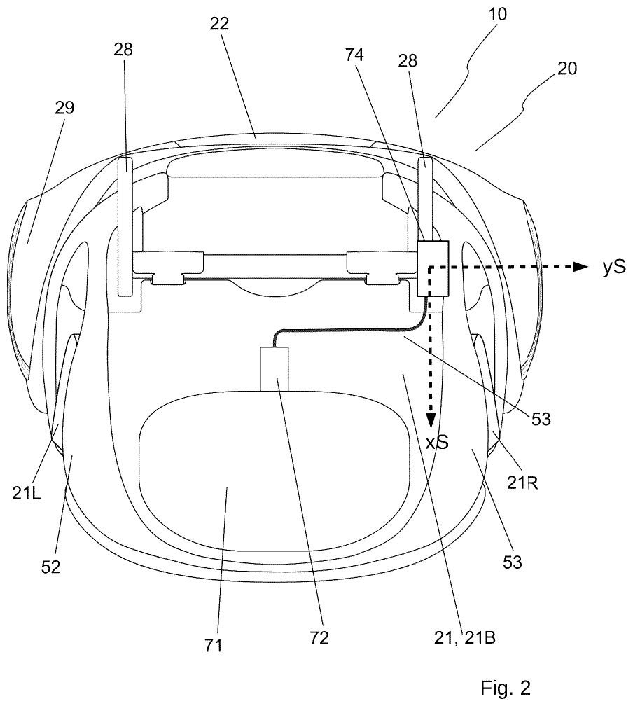

FIG. 2 a view of the child seat according to FIG. 1 from below;

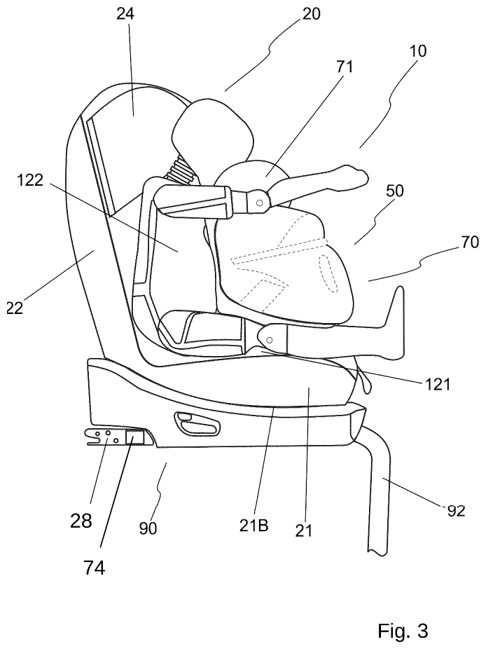

FIG. 3 a side view of another child seat with deployed or inflated airbag;

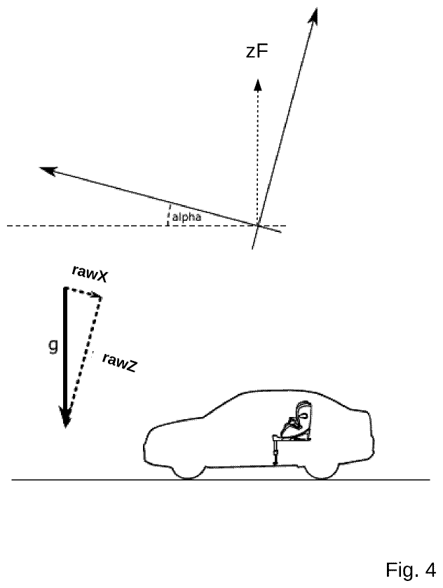

FIG. 4a (highly) schematic representation of the measured acceleration values in a vehicle on a flat surface;

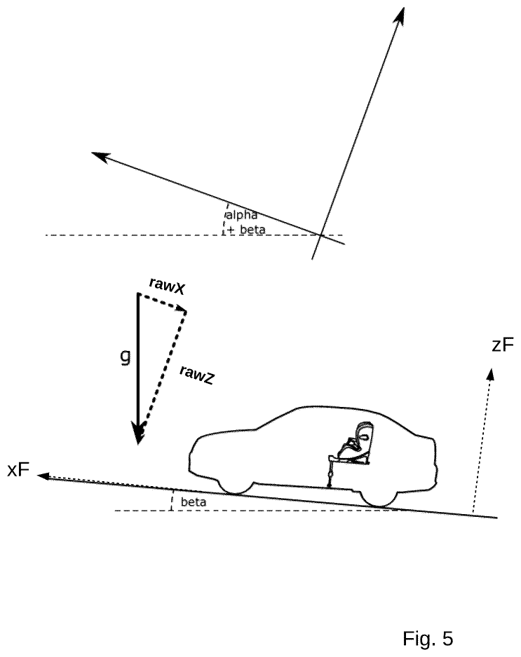

FIG. 5a (highly) schematic representation of the measured acceleration values in a vehicle travelling uphill;

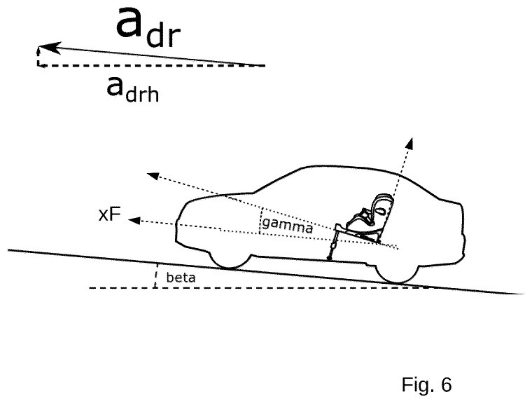

FIG. 6 a further illustration of calculated acceleration values in a vehicle;

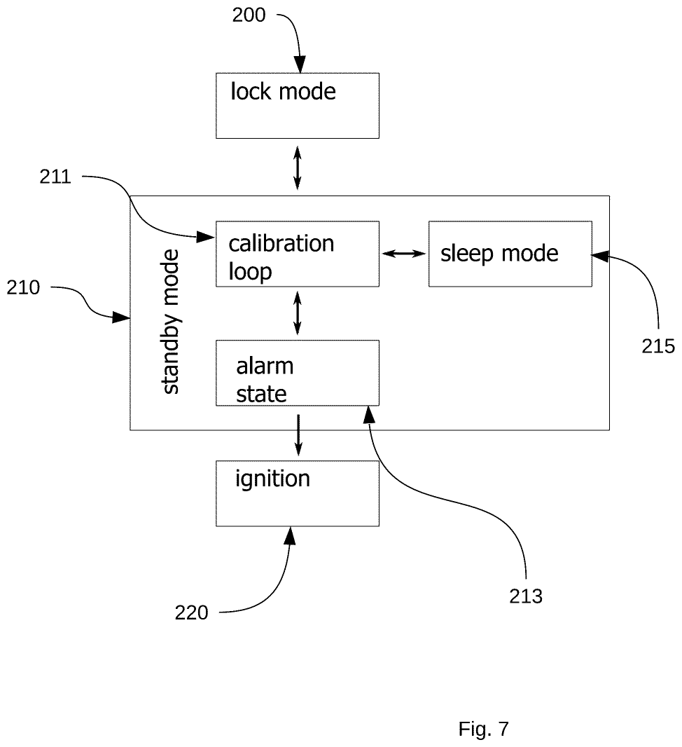

FIG. 7 a schematic illustration of some operating modes for a control unit for triggering the airbag for the child seats according to FIGS. 1 and 3;

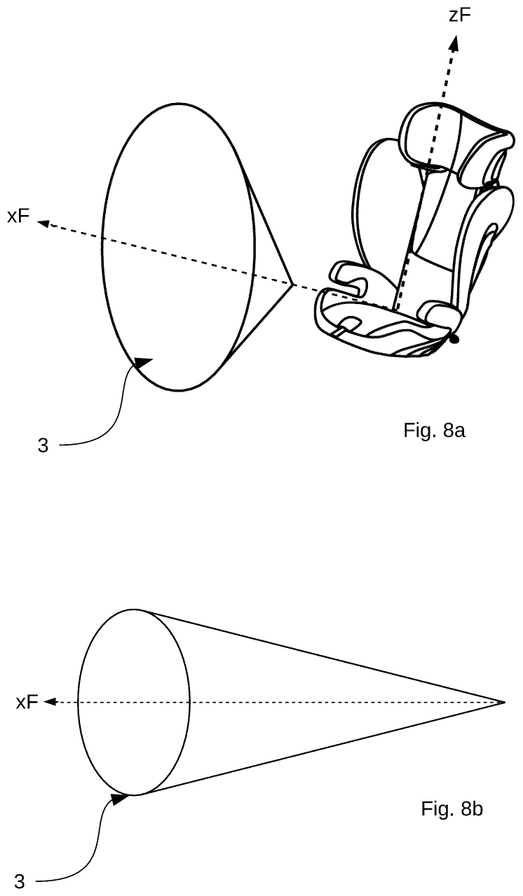

FIGS. 8a and 8b a schematic representation of a measurement direction corridor;

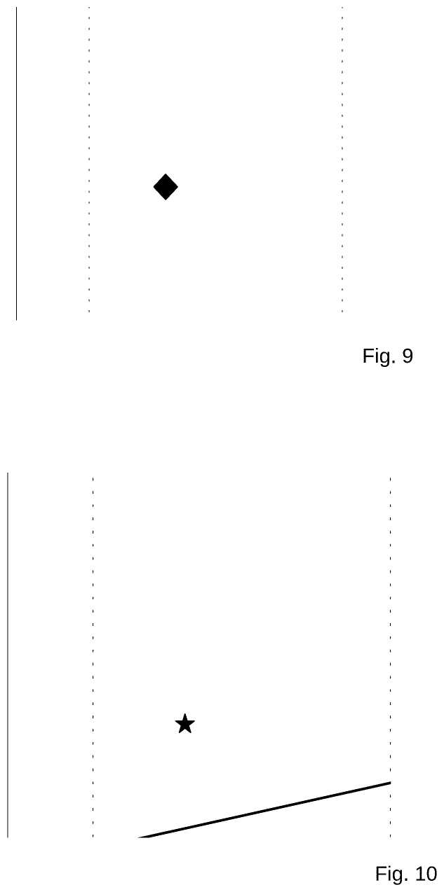

FIGS. 9 to 18 different diagrams for illustration of criteria for controlling the airbag;

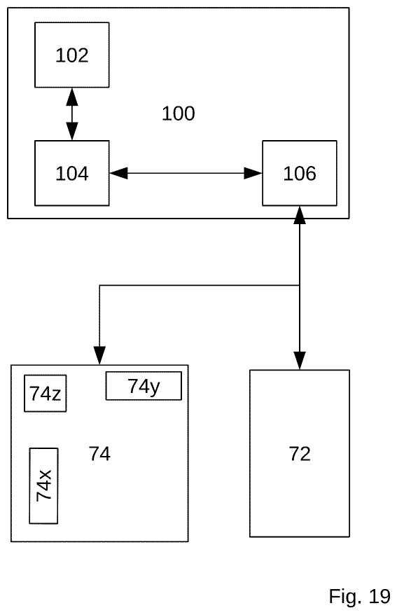

FIG. 19 a schematic representation of a control unit that is in communicative connection with a sensor unit as well as a gas generator for inflating an airbag;

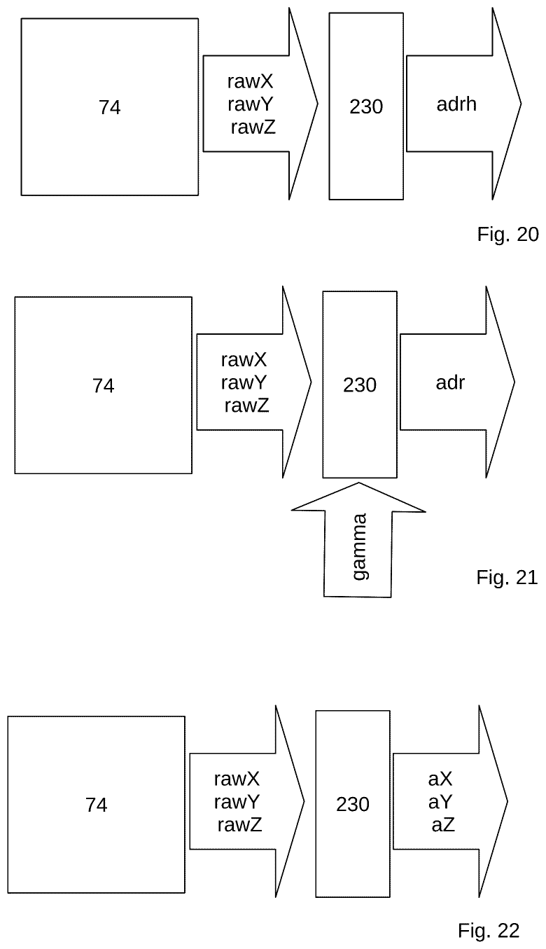

FIGS. 20 to 22 different evaluation strategies for acceleration values measured on different axes.

In the following description, the same reference numbers are used for identical and identically acting parts.

FIG. 1 shows a child seat 10, which has a main body 20, an impact shield 50 and an airbag 70 (not shown in detail). The main body 20 comprises a seat section 21 (with a centre section 21M, a left side 21L and a right side 21R), a backrest 22, side wings (or side bolsters) 23, a headrest 24, a side impact protection 29, and fastening means 28. The impact shield extends at least substantially in a transverse direction and has a central section 51, left and right sections 52, 53, and a cover 57. A first gap 121 is formed between the central section 51 (in particular its bottom surface 51B, not visible in the figure) and a centre section 21 of the seat section.

FIG. 2 shows a child seat 10 according to FIG. 1 in a view from below, wherein an airbag 70 with a gas bag 71 (in a front section of the bottom surface 21B of the seat section 21), a gas generator 72 and a sensor unit 74 is provided. The sensor unit 74 is communicatively connected to a control unit (or controller) 100 not shown in FIG. 2.

FIG. 3 shows a child seat 10 which can largely correspond to the child seat according to FIGS. 1 and 2, whereby differences are explained below. The child seat 10 according to FIG. 3 has a main body 20 which has a base 90 (in contrast to that according to FIG. 1), an impact shield 50 and an airbag 70. Like the child seat 10 of FIG. 1, the main body 20 comprises a seat section 21, a backrest 22 and a headrest 24. The impact shield 50 extends (at least substantially) in a transverse direction. The airbag 70 comprises a gas bag 71 which, in the non-shown uninflated state, is placed around a central section of the impact shield 50 (not shown) and a gas generator 72 which is preferably arranged in a cavity of the impact shield 50 and is communicatively connected to a control unit (a controller) 100.

The base 90 has a support foot 92, fastening means 28 (in particular Isofix anchor) and a control unit 100 (not shown), wherein the control unit 100 is communicatively connected, for example via a bus, to a sensor unit 74 which is arranged in, on or near (e.g. at a distance of less than 10 cm or less than 5 cm) the fastening means 28.

FIG. 3 shows, as explained, the airbag 70 in its inflated state. The gas bag 71 is filled with gas, so that the first gap 121 and a second gap 122 are (now) more narrowly formed to restrain the child from an (initially) forward movement relative to the child seat 10. A bulge in the surface of the upper surface is configured to receive the child's head. The gas bag 71 of this embodiment may have a volume of at least 3 litres, preferably at least 5 litres, and/or a volume of less than 15 litres, preferably less than 10 litres.

FIG. 19 schematically shows the gas generator 72 as well as the sensor unit 74, which are communicatively connected to the control unit 100. In one embodiment of the invention, the sensor unit 74 is a 3-axis sensor that can determine acceleration values rawX, rawY, rawZ on three different axes (x, y, z) by means of the acceleration sensors 74x, 74, 74z, which are orthogonal to each other. The corresponding sensor signals are communicated to the control unit 100 via a bus, for example. The control unit 100 receives the sensor signals via an interface 106. The interface 106 is also in communicative connection with the gas generator 72. A bus communication can also be established here. The communicative connection to the gas generator 72 is used to check its status and/or to activate it by means of a triggering signal, so that the gas bag 71 is filled.

The control unit 100 can be a control and regulation unit. This can either be a (mini) computer or dedicated hardware that has been customised for the specific application. The control unit 100 shown in FIG. 19 comprises a memory 102 for storing status data as well as for storing instructions that are executed by a computing unit 104 in order to implement a suitable control strategy.

FIG. 7 illustrates a corresponding control strategy. In one embodiment example, the control unit 100 can implement a state machine that substantially has the operating states as shown in FIG. 7. These are a lock mode 200, a standby mode 210 as well as an ignition mode 220.

It may be envisaged the control unit 100 switches to standby mode 210 (and otherwise remains in lock mode 200) precisely when at least one or more (possibly all) of the following conditions are met:
Child seat 10 is correctly coupled to the vehicle seat (preferably: Isofix or LATCH are correctly coupled) child is in the child seat 10 (in particular detected by a weight sensor, e.g. in the seat section)
child is correctly secured, for example
   harness is closed (all, preferably the two, belt tongues of the shoulder and lap belts are correctly connected to the crotch belt harness); if necessary, additionally or alternatively, one or more belts are tensioned above a predefined threshold value,
   impact shield 50 is correctly attached (all fastening means are correctly attached, the respective engagement means are in engagement with each other; if necessary, additionally or alternatively, one or more belts are tensioned above a predefined threshold value)
support foot 25 is correctly installed, in particular force-loaded (in that it rests with a lower end on a vehicle floor, while an upper end, preferably rotatable (in particular foldable for space-saving storage), is connected to another component of the child seat 10, in particular to the seat base and/or the seat section 21 and/or the backrest 22)

The transfer between lock mode 200 and standby mode 210 can be realised by switches which open or close depending on the result of the measurement of an associated sensor and can thus, for example, close an electrical circuit (e.g. with the energy source).

In standby mode 210, the child seat 10 is basically in a state in which the airbag 70 can be triggered. In other words, all general conditions are fulfilled so that reliable measurements can be taken to ensure that a specific triggering criterion that ultimately leads to ignition is actually fulfilled.

In one embodiment example, the standby mode 210 comprises three states, namely a calibration mode 211, an alarm mode 213 and a sleep mode 215. After exiting the lock mode 200, the state machine implemented by the control unit 100 preferably enters a calibration mode 211, which in one embodiment example runs through a calibration loop. In this calibration loop, the acceleration values rawX, rawY, rawZ are measured and, based on these, it is attempted to determine a basic orientation of the acceleration sensors 74x, 74y, 74z relative to the acceleration due to gravity. Depending on the information available, a direction of travel or a direction of movement of a vehicle in a horizontal plane drh (perpendicular to the gravitational force) or in a vehicle plane dr (e.g. laid through the axles of the vehicle) can be determined based on acceleration values rawX, rawY, rawZ.

This direction of travel can be used to check the criteria for entering the alarm mode as well as triggering criteria. Sleep mode 215 is provided to conserve energy when the airbag 70 is in operational standby mode 210, but for a predetermined time the only measured acceleration is the acceleration due to gravity g. This means that it can be assumed that the vehicle is not moving or is only moving to such a small extent that triggering the airbag 70 makes no sense. The transfer of the system to sleep mode 215 can be done based on a comparison of the acceleration values rawX, rawY, rawZ with the values to be expected based on the acceleration due to gravity. Certain tolerances can be provided for here. The system returns to calibration mode 211 if the criteria for sleep mode are no longer met.

In one embodiment, the calibration loop is run continuously in calibration mode 211 in order to detect and take into account realignments of the vehicle at all times. In other words, the vehicle plane is continuously re-determined by means of the measured gravitational acceleration g in order to estimate or calculate an alignment of the child seat 10 and/or the sensor unit 74 based on the vehicle plane.

A transition to the alarm mode 213 can then take place if a calculated x-acceleration value aX (in the vehicle plane, corresponds to adr in this embodiment example) is above a predefined threshold value. This threshold value can, for example, be at 2×g (i.e. twice the acceleration due to gravity). That means, the basic idea is that the control unit 100 transitions to alarm mode 213 if a significant acceleration is detected in a measurement direction (in the embodiment example described, this corresponds to the direction of travel), as is usual in the event of an accident, and as is not usually achieved during braking, for example. However, in order to avoid false triggering, in the embodiment example according to FIG. 7, it is not switched directly to ignition mode 220. Instead, the embodiment example provides for at least one triggering criterion to be checked in the alarm mode 213 before actual triggering takes place.

It is an (independent or further) aspect of the present invention that in the triggering criteria, the acceleration on different axes is considered separately. In a preferred embodiment example, illustrated in more detail below, only the acceleration forces that occur substantially in the direction of travel of the vehicle are to be taken into account. FIGS. 8a and 8b illustrate corresponding measurement directions or measurement direction corridors 3. In the embodiment example described below, only acceleration values that occur along the longitudinal axis xF of the vehicle can be taken into account, regardless of the orientation of the acceleration sensors 74x, 74y, 74z. However, as shown in FIGS. 8a and 8b, it is also possible to allow a corridor 3 of acceleration values that are taken into account when determining the triggering criteria. As shown in FIGS. 8a, 8b, the corridor 3 can be a cone whose origin lies in the centre of the child seat 10 or the sensor unit 74. It is understood that such a cone can be reduced to an angular range when using only two acceleration sensors, e.g. 74x and 74z.

In one embodiment example, the sensor unit 74 may be mounted exactly such that the y acceleration sensor 74y is orientated exactly parallel or coaxial to the transverse axis of the vehicle yF (e.g. parallel to an axis of the vehicle). Since child seats 10 are usually mounted with at least substantially the same lateral orientation (the child looks with or against the direction of travel), the y-acceleration sensor 74y can be mounted in the child seat 10 in a corresponding manner ex works. Since the x-acceleration sensor 74 and the z-acceleration sensor 74z are arranged orthogonally to each other as well as orthogonally to the y-acceleration sensor 74y, no (lateral) acceleration forces act on the x-acceleration sensor 74x and the z-acceleration sensor 74z when the vehicle is travelling in a straight line. This means that a two-dimensional view can be taken, as in FIGS. 4 to 6. The y-component of the acceleration can (at least initially) be ignored in this embodiment example.

If a vehicle is travelling or standing parallel to the horizontal plane—on a flat road—as illustrated in FIG. 4, the x acceleration sensor 74x can be inclined by an angle alpha relative to the horizontal plane. This can be based on the fact that the x-acceleration sensor 74x is inclined relative to a flat arrangement of the child seat 10 (in relation to the vehicle plane). In the embodiment example shown in FIG. 4, the coordinate system of the child seat 10 is equated with the coordinate system of the vehicle to explain the angle alpha. Thus, in this illustration, the longitudinal axis xS, the transverse axis yS and the vertical axis zS of the child seat coincide with the longitudinal axis xF, the transverse axis yF and the vertical axis zF of the vehicle. Despite the vehicle being levelled, the acceleration due to gravity g breaks down into measured x-acceleration values rawX and measured z-acceleration values rawZ, which are detected by the sensor unit 74 tilted by the angle alpha.

In FIG. 5, the vehicle is now travelling uphill relative to the horizontal plane or is aligned accordingly. As shown in FIG. 5, the road and thus the vehicle plane is inclined by an angle beta relative to the horizontal plane.

The coordinate system of the sensor unit 74 is therefore inclined relative to the horizontal plane by the sum of the angles alpha and beta (in the example, about the transverse axis yF of the vehicle). The acceleration due to gravity g is distributed even more over the x-acceleration sensor 74x as well as the z-acceleration sensor 74z (the x-acceleration value increases). If the angle alpha is known and it is assumed that the child seat 10 is aligned parallel to the plane of the vehicle, the acceleration in the direction of travel a_{dr} can easily be determined from the measured acceleration values rawX, rawZ after an appropriate calibration (see calibration mode 211). The angle alpha can, for example, be set on the basis of an external input or ex works. If the angle alpha is not known, the acceleration in the direction of the horizontal component of the direction of travel a_{drh}—i.e. in the horizontal plane—can be determined in one embodiment example (see FIG. 20). Both approaches are sufficient to achieve a (significant) improvement in the triggering behaviour compared to the state of the art.

FIG. 6 introduces the gamma angle as a further angle. This indicates an inclination of the child seat 10 relative to the vehicle plane about the transverse axis yF. This angle gamma models the fact that vehicle seats are often inclined in relation to the vehicle plane, resulting in an inclined alignment of the child seat 10. The angle gamma is estimated in one embodiment example. In another embodiment example, a separate measurement (for example if it is known that the vehicle is currently on a horizontal plane) of the angle gamma can be made or the angle gamma can be set by an input from a user. If gamma is estimated, a value of 0 to 30° is preferably used, more preferably a value of 10° to 20°. If the angle gamma is not known, the acceleration in the direction of the horizontal component of the direction of travel a_{drh}—i.e. in the horizontal plane-can be determined in one embodiment example (see FIG. 20). This approach is sufficient to achieve a (significant) improvement in the triggering behaviour compared to the state of the art.

As already explained, the acceleration in the direction of travel a_{dr} (or, according to embodiment as explained, a_{drh} instead) can be used to determine whether the child seat 10 should switch from calibration mode 211 to alarm mode 213. Accordingly, these measurements or the calculated value of the acceleration in the direction of travel a_{dr} (possibly a_{drh}) can be used to determine whether an ignition of the airbag 70, i.e. a transition from the alarm mode 213 to the ignition mode 220, is indicated. There are different strategies in this regard. In particular, criteria can be provided according to which it is decided whether the alarm mode 213 is maintained, whether a change to the ignition mode 220 is indicated, or whether the alarm mode 213 (without ignition) is cancelled (e.g. return to the calibration mode 211).

In one embodiment example, based on the value a_{dr} (possibly a_{drh}) it is continuously compared over time with two curves. The first curve specifies threshold values over time that cause the system to return to calibration mode 211. The second curve is also a threshold value over time, whereby if these threshold values specified by the second curve are exceeded, it is switched from alarm mode 213 to ignition mode 220.

Instead of considering the specific acceleration value a_{dr} (or a_{drh}), in one embodiment example a differential speed Δv or Deltav is calculated and considered from the time at which the control unit has transitioned to alarm mode 213. The differential speed Deltav is preferably based on the complete acceleration information (and not only on the acceleration in the direction of measurement). For example, the measured acceleration values rawx, rawy, rawz can be used to determine a differential speed (since transition to alarm mode) in three-dimensional space.

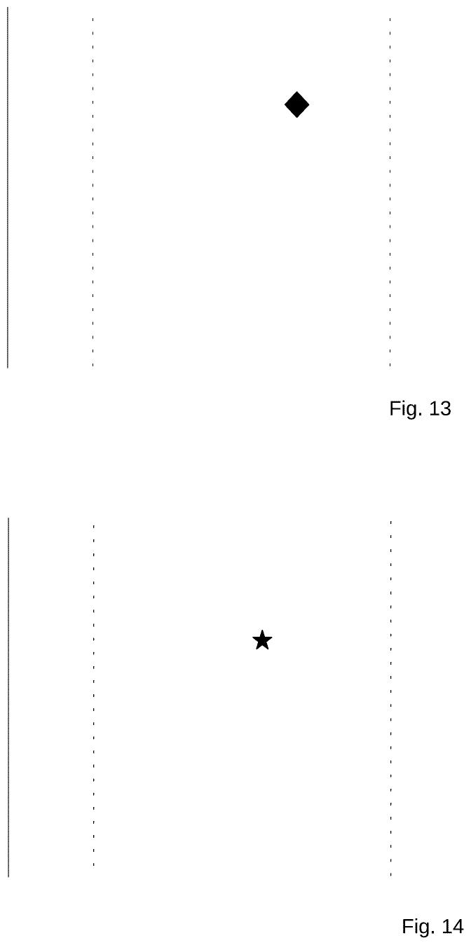

In one embodiment example, the direction of the acceleration vectors used to determine the differential speed can be used as an additional trigger criterion (direction criterion). Thus, after the differential speed has exceeded a threshold value (see explanations on FIGS. 13 to 15), it can be checked whether the sum of the acceleration vectors lies within a target corridor. The target corridor can be the measurement direction corridor 3 shown in FIGS. 8a, 8b.

FIG. 9 shows a substantially static first curve over time, in which for the cancellation a specific threshold value is defined in the time interval between t₁ and tₘₐₓ. The curve is to be understood in such a way that the measured value illustrated by means of a diamond as an example does not lead to a cancellation, but to the alarm mode 213 being maintained. As an additional cancellation criterion, the control unit 100 can specify that an automatic cancellation takes place after the time tₘₐₓ if no ignition has taken place by then.

FIG. 10 shows an alternative for the first curve, which, like the curve in FIG. 9, is defined between t₁ and tₘₐₓ and increases linearly. This first curve therefore specifies that in order to maintain the alarm mode 213, an increasingly higher requirement is placed on the determined differential speed Deltav over time. If the differential speed Deltav falls below the specified solid line, this leads to a cancellation (change to calibration mode 211). A corresponding exemplary value is symbolised by an asterisk in FIG. 10.

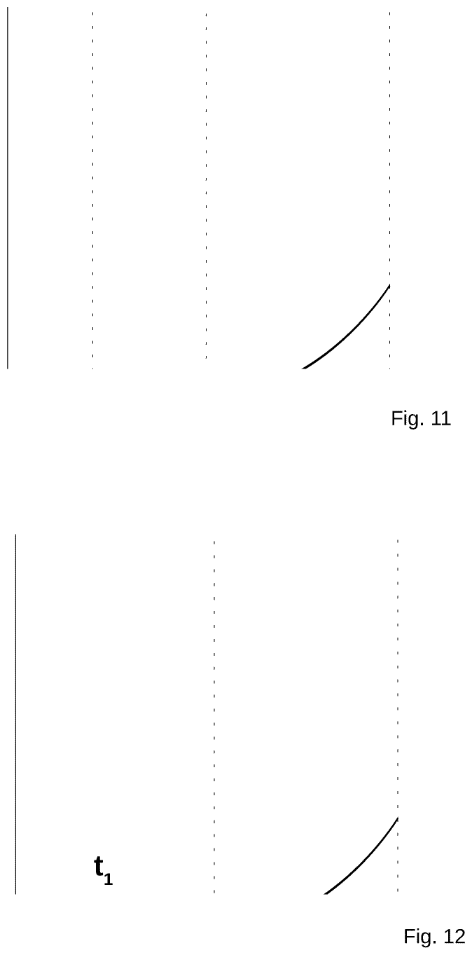

According to the invention, the corresponding first curves can be structured in an arbitrary complicated manner. FIG. 11 shows an embodiment example in which the threshold value is constant between the times t₁ and t₂, to then increase from t₂ to tₘₐₓ.

FIG. 12 shows an embodiment of the first curve, which is defined between t=0 and tₘₐₓ and initially runs along the x-axis (differential speed=0).

At time t₁, the first curve rises abruptly and then follows the course of the example illustrated in FIG. 11. In contrast to the situation illustrated there, however, a cancellation can occur from the beginning (t=0) if an acceleration takes place in the opposite direction to that originally measured, so that the differential speed Deltav falls below 0.

FIGS. 13 to 18 show possible configurations of the second curve, which specifies threshold values over time, wherein upon its exceedance a change to ignition mode 220 takes place. A corresponding differential speed is illustrated in FIG. 13 with a black diamond. In an embodiment example it leads to a triggering of the airbag. The curve in FIG. 13 is defined in the period between t₃ and tₘₐₓ and specifies constant threshold values. In one embodiment example, triggering can only take place if further triggering criteria are fulfilled (see, for example, the direction criterion already explained or temperature criteria or criteria relating to information provided by the vehicle bus, etc.).

FIG. 14 shows a possibility for a second curve, which is defined between t₃ and tₘₐₓ and increases linearly. As long as the specified threshold value is not exceeded, no ignition of the airbag 70 takes place (cf. exemplary value in the form of a star).

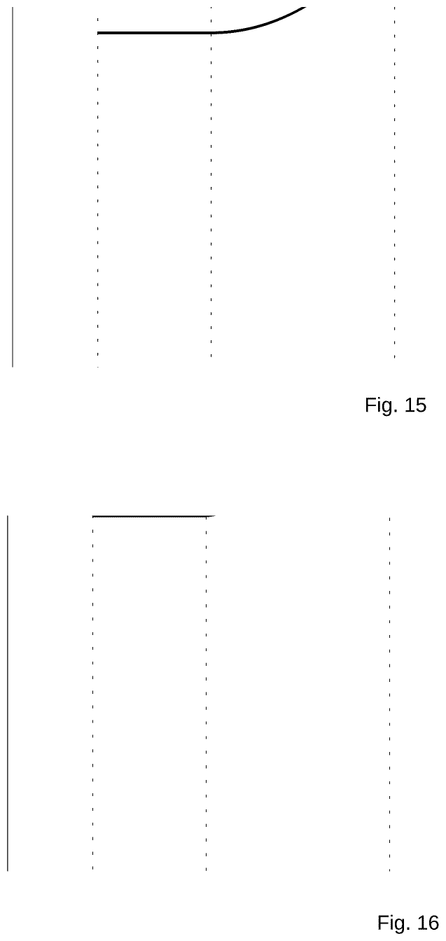

FIG. 15 shows a possibility for a second curve, which is defined between t₃ and tₘₐₓ and is constant in a first range between t₃ and t₄, to then increase more and more from t₄ to tₘₐₓ.

FIG. 16 shows almost the same situation as FIG. 15, but here the second curve rises much more sharply as tₘₐₓ is approached, so that the gradient becomes (almost) infinite.

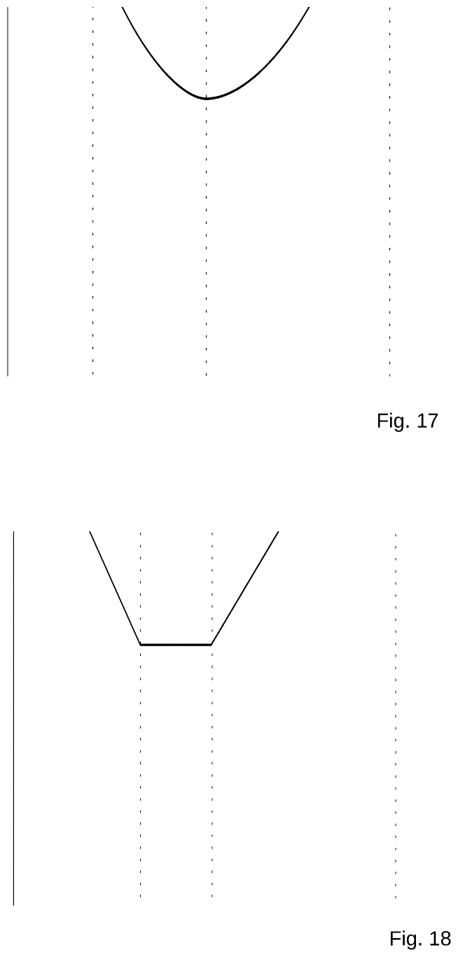

FIG. 17 shows another embodiment example, where the second curve is defined between t₃ and tₘₐₓ and falls in a first range between t₃ and t₄, to then rise from t₄ to tₘₐₓ.

FIG. 18 shows a possibility for a second curve which is defined between t=0 and tₘₐₓ, whereby it initially falls linearly from t₀ to a time t₄, then remains constant up to a time t′₄ and finally rises linearly up to tₘₐₓ.

According to the invention, the individual first and second curves can be combined with each other in any desired form. Ultimately, they define corridors that cause the system to remain in alarm mode 213. If the corridor is undercut, the method continues in calibration mode 211 and waits for a new entry into alarm mode 213. If the corridor is exceeded, ignition takes place, provided there are no further triggering criteria that still need to be fulfilled.

In some of the embodiment examples described, the measured acceleration values were mapped to a relevant acceleration value adr along the measurement direction by the control unit 100 on the basis of available information (angle alpha, beta and gamma) and taking into account selected configurations (y acceleration sensor is aligned parallel or coaxially to the transverse axis yF of the vehicle) (cf. FIG. 21).

In another embodiment example, the calculated acceleration value a_{drh} (in the horizontal plane) can be used instead of the acceleration value adr (along the direction of travel in the vehicle plane) (FIG. 20). This is indicated if the angle gamma or generally the orientation of the sensor unit 74 relative to the vehicle plane cannot be conclusively determined.

The invention was previously described in connection with protective means in the form of airbags which are inflated using a gas generator, for example a pyrotechnic cartridge. According to the invention, other (active) protective means, such as belt tensioners, which are operated by an electric motor or pyrotechnic means, can also be used. The gas generator can also be designed as a pressure store, for example as a cartridge with a pressurised propellant.

However, the invention can also be implemented with several calculated acceleration values aX, aY, aZ, which are each determined based on the measured acceleration values rawX, rawY and rawZ.

Numerous methods for triggering (active) protective means have been described above. This means that the methods are basically suitable for triggering different protective means. This does not mean that the methods trigger several protective means in a specific individual case or are implemented in such a way that they can trigger several protective means simultaneously or one after the other. Rather, the triggering of a single protective means is sufficient to realise the methods according to the invention.

At this point, it should be noted that all of the parts described above, taken individually and in any combination, in particular the details shown in the drawings, are claimed as further embodiments of the invention. Modifications thereof are possible.

At this point, it is also be pointed out that all of the parts or features described above are in each case individually-even without features additionally described in the respective context, even if these have not been explicitly identified individually as optional features in the respective context, e.g. by using: in particular, preferably, for example, e.g., optionally, round brackets etc., or in combination or any sub-combination are to be regarded as independent embodiments or further developments of the invention, as defined in particular in the introduction to the description as well as the claims. Deviations from this are possible. Specifically, it is pointed out that words in particular or round brackets are intended to explicitly characterise non-mandatory features in the respective context.

Finally, it is pointed out that the present application for a protective right (in the event of registration or grant: the present protective right) aims for a scope of protection for the invention as broad as possible as broadly as possible. It is requested to bear this in mind when reading, particularly insofar as it concerns (intermediate) generalisations of explicitly disclosed features or combinations of features.

### REFERENCE SIGNS

10 child seat
20 main body
21 seat section
21R right side (of the seat section)
21L left side (of the seat section)
21B bottom side/lower side (of the seat section)
21M centre section (of the seat section)
22 backrest
23 side wings/side bolster
24 headrest
25 support foot
26 top tether
28 fasteners (e.g. Isofix)
29 side impact protection
50 impact shield
52 left impact shield section
53 right impact shield section
54 fixed section (of the impact shield)
55 cushioning (of the impact shield)
57 cover
58 first section
59 second section
70 airbag
71 gas bag
72 gas generator
74 sensor unit
74x x-axis sensor
74y y-axis sensor
74z z-axis sensor
77 steering device
78 proximal section
79 distal section
80 gas outlet
81 gas inlet
82 sealing
83, 83′ coupling means
84 channel
90 base
90B bottom side/lower side (of the base)
92 support foot
100 control unit
102 memory
104 computing unit
106 interface
200 lock mode
210 standby mode
211 calibration mode
213 alarm mode
215 sleep mode
220 ignition mode
rawX measured acceleration value (X-axis)
rawY measured acceleration value (Y-axis)
rawZ measured acceleration value (Z-axis)
ax calculated acceleration value (X-axis)
aY calculated acceleration value (Y-axis)
aZ calculated acceleration value (Z-axis)
xS,yS,zS longitudinal axis, transverse axis, vertical axis of the child seat
xF,yF,zF longitudinal axis, transverse axis, vertical axis of the vehicle
Deltav differential speed

1. A method for triggering protective means, including an airbag and/or a belt tensioner, in a child restraint device, comprising:
determining at least one measurement direction or one measurement direction corridor;
receiving acceleration sensor signals from at least two acceleration sensors, which are orientated differently;
calculating at least one first acceleration value along the measurement direction or within the measurement direction corridor;
determining a triggering signal based on the at least one first acceleration value; and
triggering at least one protective means based on the triggering signal.

2. The method according to claim 1, wherein a plurality of acceleration values, are determined or calculated over time.

3. The method according to claim 1, wherein an alarm mode is adopted when at least one alarm criterion is fulfilled, wherein an alarm criterion is fulfilled when the first acceleration value, is above a threshold value.

4. Method The method according to claim 3, wherein in the alarm mode at least one triggering criterion is checked,
wherein one of the or the at least one triggering criterion is based on at least one acceleration value or based on a differential speed calculated on the basis of at least one acceleration value, or varies over time,
wherein the protective means is triggered when the at least one triggering criterion is fulfilled in the alarm mode.

5. The method according to claim 4, wherein at least one cancellation criterion is checked in the alarm mode, wherein the alarm mode is terminated when at least one of the cancellation criteria is fulfilled, wherein the cancellation criteria comprise:
i) a timeout, in an exceedance of a maximum time interval since entering the alarm mode; or
ii) exceeding a maximum number of calculations in calculating at least one first acceleration value; or
iii) falling below a threshold value by the first acceleration value; or
iv) falling below a threshold value by one of the calculated differential speeds.

6. The method according to claim 5, wherein at least one of the cancellation criteria varies over time, wherein a start time is set based on entry into the alarm mode.

7. The method according to claim 1, wherein in a calibration step, a reference plane is determined using a gravitational vector or a gravitational force determined by the acceleration sensor signals, wherein the measurement direction or the measurement direction corridor is determined using the reference plane.

8. The method according to claim 7, wherein the reference plane is a vehicle plane, which comprises a direction of a travel vector, wherein the vehicle plane is determined using an input including an angle of inclination.

9. The method according to claim 8, wherein the gravitational vector or the reference plane is determined using a plurality of acceleration sensor signals, including a plurality of acceleration sensor signals of a first acceleration sensor and a plurality of acceleration sensor signals of a third acceleration sensor.

10. The method according to claim 8, wherein the gravitational vector or the reference plane is updated continuously or iteratively or calibration is performed continuously or iteratively.

11. The method according to claim 1, wherein at least one sleep mode criterion is determined using the acceleration values, wherein a sleep mode is adopted when the at least one sleep mode criterion is present, wherein in the sleep mode a determination of acceleration values, including the first acceleration value, is determined with a first frequency which is smaller than a second frequency assigned to a non-sleep mode.

12. The method according to claim 1, further comprising:
calculating at least one differential speed using the acceleration sensor signals; and determining the triggering signal based at least on the at least one differential speed.

13. The method, according to claim 1, wherein
the receiving acceleration sensor signals includes receiving a first acceleration sensor signals and receiving a second acceleration sensor signals; and
wherein the determining at least one measurement direction or the one measurement direction corridor includes iteratively determining based on the first acceleration sensor signals;
and wherein the determining the triggering signal includes determining based at least on the second acceleration sensor signals and using the iteratively determined measurement corridor or the measurement direction;

14. The method, in particular according to claim 1, further comprising:
comparing the at least one first acceleration value with the measurement direction or the measurement direction corridor; and
determining the triggering signal includes determining based at least on the comparison.

15. The method according to claim 1, further comprising:
checking conditions for entering a standby mode, wherein a condition includes at least one of:
correct coupling of the child restraint device to a vehicle seat,
detection of a child in a child seat,
correct securing of a child in the child restraint device,
correct installation of a support foot of the child restraint device;
and wherein the determining the triggering signal includes determining based on the acceleration sensor signals.

16. Computer-readable memory with instructions for implementing the method according to claim 1 when executed on at least one computing unit.

17. Control and regulation unit which is adapted to implement (in operation) the method according to claim 1.

18. A child restraint device with a longitudinal axis, a transverse axis, and a vertical axis, and including a child seat or impact shield, for mounting in a vehicle, or component of such a device, comprising:
at least one protective means including an airbag with at least one inflatable gas bag,
at least one drive unit including a gas generator for activating the at least one protective means,
at least one control unit for activating the at least one drive unit based on a triggering signal,
at least one sensor unit with a first acceleration sensor and with a third acceleration sensor for outputting first acceleration sensor signals and third acceleration sensor signals, respectively,
wherein the control unit is configured to receive the acceleration sensor signals and decides whether the drive unit is activated based on the first and third acceleration sensor signals.

19. The child restraint device according to claim 18, wherein the at least one sensor unit includes a primary sensor unit and a secondary sensor unit each including at least two acceleration sensors, wherein the acceleration sensors of the primary sensor unit are sampled at a higher rate than those of the secondary sensor unit.

20. The child restraint device or component of such a device according to claim 18, wherein the first acceleration sensor is configured for detecting a first acceleration value and the third acceleration sensor is configured for detecting a third acceleration value, in a detection direction which extends at least substantially in, or parallel to, a plane which is spanned by a vertical axis and a longitudinal axis of the child restraint device, or wherein
the first acceleration sensor and the third acceleration sensor are arranged at least substantially orthogonally to one another, or wherein
the at least one sensor unit includes a second acceleration sensor, the second acceleration sensor arranged at least substantially parallel or coaxial to a transverse axis, or wherein
the first acceleration sensor is configured for detecting the first acceleration value and is arranged in the detection direction which has an angle of more than 5 degrees or an angle of less than 30 degrees relative to a longitudinal axis of the vehicle.

21. The child restraint device according to claim 18, wherein at least one energy store includes a battery for supplying the control unit or the gas generator.

22. The child restraint device according to claim 18, wherein
the at least one inflatable gas bag can be converted from a non-inflated state into an inflated state, or wherein
the at least one inflatable gas bag is at least substantially unfolded in the non-inflated state, and/or or wherein
an outer surface of the at least one inflatable gas bag, in the non-inflated state of is configured such that, for at most 25% of the outer surface applies, that a respective outer surface perpendicular intersects the outer surface at a second point of the outer surface, or wherein
in the non-inflated state, at most 25% of the outer surface of the gas bag is in direct contact with another part of the outer surface.

23. The child restraint device according to claim 22, wherein at least one pressure limiting device is associated with the at least one inflatable gas bag in such a way that, when a predetermined pressure is reached or exceeded at least locally, pressure is relieved by gas escaping from the gas bag, the pressure relief in the event of release at least in a lower or rear region of at least one inflatable the gas bag or at an edge of the at least one inflatable gas bag.

24. The child restraint device according to claim 22, wherein the at least one inflatable gas bag in the inflated state has a thickness of at most 30 cm, or is at least substantially flat and has a thickness which is smaller than an expansion in at least one direction perpendicular to a thickness direction, or a point furthest away from the rest of the child restraint device or component thereof is at most 30 cm, or the at least one airbag in the inflated state has an internal volume of at most 20 litres, or at least 1 litre.
